(19) United States
(12) Patent Application Publication
(10) Pub. No.: US 2026/0185852 A1
(43) Pub. Date: Jul. 2, 2026

(54) SILICON GYROSCOPE DETECTION CIRCUIT BASED ON SAMPLE-HOLD AND INTEGRAL FEEDBACK

(71) Applicant: Wenzhou University, Zhejiang (CN)

(72) Inventors: Ziyu Zhou, Zhejiang (CN); Xiangyu Li, Zhejiang (CN); Shanshan Wang, Zhejiang (CN); Hao Ye, Zhejiang (CN); Pengjun WANG, Zhejiang (CN)

(73) Assignee: Wenzhou University, Zhejiang (CN)

(21) Appl. No.: 19/420,769

(22) Filed: Dec. 16, 2025

(30) Foreign Application Priority Data
Jan. 2, 2025 (CN) 202510000379.4

(51) Int. Cl. G01C 25/00; G01C 19/5776

(52) U.S. Cl. CPC G01C 25/005; G01C 19/5776

(57) ABSTRACT

The invention discloses a silicon gyroscope detection circuit based on sample-hold and integral feedback, including a charge amplifier, a proportional amplifier, a filter, a sample-hold circuit, an integrator and a buffer. The charge amplifier, the proportional amplifier and the filter constitute a detection branch to sequentially convert, amplify and filter a charge signal generated by inductive rotation of a silicon gyroscope, thus improving the signal-to-noise ratio and the detection precision; and the sample-hold circuit, the integrator and the buffer constitute a feedback branch to sample, amplify and buffer a detection signal in real time to form a feedback signal, which is fed back to the charge amplifier and superimposed with the charge signal generated by inductive rotation of the silicon gyroscope, such that a closed-loop detection process is formed to compensate for in real time errors caused by interferences including noise, temperature, nonlinearity and circuit parameter variations.

### CROSS-REFERENCE TO RELATED APPLICATION

This application claims the priority benefit of China application serial no. 202510000379.4, filed on Jan. 2, 2025. The entirety of the above-mentioned patent application is hereby incorporated by reference herein and made a part of this specification.

### BACKGROUND

### Technical Field

The invention relates to silicon gyroscope detection circuits, in particular to a silicon gyroscope detection circuit based on sample-hold and integral feedback.

### Description of Related Art

A silicon gyroscope is obtained by integrating a plurality of gyroscopes and other sensors on a single silicon wafer by lithography and etching based on the micro-electro-mechanical system (MEMS) technique. The silicon gyroscope is used for detecting changes of the angular velocity and angle, have the advantages of small size, low weight, lower power and low cost, and are widely applied to inertial navigation systems such as navigation and control of aircrafts and missiles, precision measuring instruments such as earthquake monitoring equipment and high-accuracy positioning systems, automotive electronic systems such as an electronic stability control system (ESC) and an anti-lock braking system (ABS), and industrial automation such as robot control and high-precision machining.

Chinese Patent No. CN201610372696.X discloses a system for improving the zero-drift performance of a silicon micromechanical gyroscope packaged under normal pressure. In this system, and an open-loop detection circuit, as a silicon gyroscope detection circuit, in the system is used for detecting output signals of the silicon gyroscope and includes a capacitance-voltage conversion and amplification circuit, a phase compensation circuit, a switch demodulation circuit and a lowpass filter; the capacitance-voltage conversion and amplification circuit is configured to convert a capacitance variation in a detection mode into a voltage signal and amplify the voltage signal; the phase compensation circuit is configured to compensate for an additional phase generated by a small quality factor to make a to-be-demodulated signal output by the capacitance-voltage conversion and amplification circuit and a reference signal output by a driving axial structure always satisfy a demodulation phase relation; the switch demodulation circuit is configured convert the signal output by the capacitance-voltage conversion and amplification circuit into a direct-current signal and a double-frequency signal after the to-be-demodulated signal and the reference signal are input to the switch demodulation circuit, and extract angular velocity information by means of the direct-current signal; and the lowpass filter is configured to filter out the double-frequency signal output by the switch demodulation signal and reserve the direct-current signal.

When the open-loop detection circuit is used for detection, first, the inherent noise of the circuit (thermal noise of electronic devices, noise of sensor materials and electromagnetic interference noise in the environment) will affect the detection precision; second, the problem of zero-drift caused by temperature variations, aging and environmental stress is serious, leading to instability of detection results; finally, on one hand, because the silicon material adopted by the silicon gyroscope is sensitive to the temperature variation, a signal output by the open-loop detection circuit drifts with the temperature variation, and thermal noise will still be caused by the temperature variation even in the presence of temperature compensation, reducing the detection precision; on the other hand, in a case where the angular velocity is high or changes quickly, the response of the silicon gyroscope may exhibit nonlinear characteristics, leading to detection errors.

Therefore, the above open-loop detection circuit has low detection precision. Although detection errors caused by the nonlinear characteristics of the silicon gyroscope may be reduced by adopting a complex calibration and compensation scheme, the improvement in the detection precision is limited, and the cost is greatly increased.

### SUMMARY

The technical issue to be settled by the invention is to provide a silicon gyroscope detection circuit based on sample-hold and integral feedback, which has high detection precision and detection stability.

The technical solution adopted by the invention to settle the above technical issue is as follows: a silicon gyroscope detection circuit based on sample-hold and integral feedback includes a charge amplifier, a proportional amplifier, a filter, a sample-hold circuit, an integrator and a buffer, wherein the charge amplifier is configured to convert a charge signal, generated by inductive rotation of a silicon gyroscope, into a voltage signal and output the voltage signal to the proportional amplifier, the proportional amplifier is configured to amplify the voltage signal, output thereto by the charge amplifier, to obtain an amplified signal and output the amplified signal to the filter, the filter is configured to filter the amplified signal to remove signals beyond an induction frequency band of the silicon gyroscope to obtain a signal within the induction frequency band of the silicon gyroscope and output the signal as a detection signal, the sample-hold circuit is configured to sample and hold the detection signal output by the filter to obtain a sampled signal and output the sampled signal to the integrator, the integrator is configured to perform integration on the sampled signal, output thereto by the sample-hold circuit, to obtain an integrated signal and output the integrated signal to the buffer, and the buffer is configured to buffer the integrated signal, output thereto by the integrator, to obtain a buffer signal and feed the buffer signal to the charge amplifier as a feedback signal, which is superimposed with the charge signal generated by inductive rotation of the silicon gyroscope to compensate for an error, caused by interferences including noise, temperature, nonlinearity and circuit parameter variations, to calibrate the detection signal output by the filter.

The charge amplifier, the proportional amplifier, the filter, the sample-hold circuit, the integrator and the buffer each have an input terminal and an output terminal, wherein the input terminal of the charge amplifier serves as an input terminal of the silicon gyroscope detection circuit, is connected to an output terminal of the silicon gyroscope and allows the charge signal generated by inductive rotation of the silicon gyroscope to be input thereto, the output terminal of the charge amplifier is connected to the input terminal of the proportional amplifier, the output terminal of the proportional amplifier is connected to the input terminal of the filter, the output terminal of the filter serves as an output terminal of the silicon gyroscope detection circuit and is configured to output the detection signal, the input terminal of the sample-hold circuit is connected to the output terminal of the filter, the output terminal of the sample-hold circuit is connected to the input terminal of the integrator, the output terminal of the integrator is connected to the input terminal of the buffer, and the output terminal of the buffer is connected to the input terminal of the charge amplifier and configured to output the buffer signal to the input terminal of the charge amplifier.

The charge amplifier includes a first operational amplifier, a first electronic switch, a second electronic switch, a third electronic switch, a first capacitor and a second capacitor, wherein the first operational amplifier has a non-inverting input terminal, an inverting input terminal and an output terminal; the first electronic switch, the second electronic switch and the third electronic switch each have a clock terminal and two connecting terminals, a clock signal for controlling the two connecting terminals to be connected or disconnected is input to the clock terminal, and the two connecting terminals are respectively referred to as a first connecting terminal and a second connecting terminal; the first connecting terminal of the first electronic switch serves as the input terminal of the charge amplifier; the second connecting terminal of the first electronic switch, the non-inverting input terminal of the first operational amplifier, the first connecting terminal of the third electronic switch and one terminal of the first capacitor are connected; the inverting input terminal of the first operational amplifier, one terminal of the second capacitor and the first connecting terminal of the second electronic switch are connected; the other terminal of the second capacitor and the second connecting terminal of the second electronic switch are both grounded; and the second connecting terminal of the third electronic switch, the other terminal of the first capacitor and the output terminal of the first operational amplifier are connected, and a connecting terminal serves as the output terminal of the charge amplifier.

The first operational amplifier includes a first MOS transistor, a second MOS transistor, a third MOS transistor, a fourth MOS transistor, a fifth MOS transistor, a sixth MOS transistor, a seventh MOS transistor, an eighth MOS transistor, a ninth MOS transistor, a tenth MOS transistor, an eleventh MOS transistor, a twelfth MOS transistor, a thirteenth MOS transistor, a fourteenth MOS transistor, a fifteenth MOS transistor, a sixteenth MOS transistor, a seventeenth MOS transistor, an eighteenth MOS transistor, a nineteenth MOS transistor, a twentieth MOS transistor, a twenty-first MOS transistor, a twenty-second MOS transistor, a twenty-third MOS transistor, a twenty-fourth MOS transistor, a twenty-fifth MOS transistor, a twenty-sixth MOS transistor, a twenty-seventh MOS transistor, a sixth resistor, a sixth capacitor and a seventh capacitor, wherein the first MOS transistor, the second MOS transistor, the third MOS transistor, the fourth MOS transistor, the fifth MOS transistor, the tenth MOS transistor, the twelfth MOS transistor, the thirteenth MOS transistor, the fifteenth MOS transistor, the seventeenth MOS transistor, the eighteenth MOS transistor, the nineteenth MOS transistor, the twenty-second MOS transistor, the twenty-third MOS transistor, the twenty-fourth MOS transistor and the twenty-fifth MOS transistor are all PMOS transistors; the sixth MOS transistor, the seventh MOS transistor, the eighth MOS transistor, the ninth MOS transistor, the eleventh MOS transistor, the fourteenth MOS transistor, the sixteenth MOS transistor, the twentieth MOS transistor, the twenty-first MOS transistor, the twenty-sixth MOS transistor and the twenty-seventh MOS transistor are all NMOS transistors; a supply voltage VCC is accessed to a source and a substrate of the first MOS transistor, a source and a substrate of the fourth MOS transistor, a source and a substrate of the fifth MOS transistor, a source and a substrate of the tenth MOS transistor, a source and a substrate of the twelfth MOS transistor, a substrate of the thirteenth MOS transistor, a source and a substrate of the fifteenth MOS transistor, a source and a substrate of the seventeenth MOS transistor, a source and a substrate of the eighteenth MOS transistor, a substrate of the nineteenth MOS transistor, a source and a substrate of the twenty-second MOS transistor, a source and a substrate of the twenty-third MOS transistor, a substrate of the twenty-fourth MOS transistor and a substrate of the twenty-fifth MOS transistor; a gate of the first MOS transistor, a gate and a drain of the eighteenth MOS transistor, a drain of the twenty-first MMOS transistor and a gate of the twelfth MOS transistor are connected; a drain of the first MOS transistor is connected to a source and a substrate of the second MOS transistor and a source and a substrate of the third MOS transistor; a gate of the second MOS transistor serves as the non-inverting input terminal of the first operational amplifier; a drain of the second MOS transistor, a source of the sixth MOS transistor and a drain of the eighth MOS transistor are connected; a gate of the third MOS transistor serves as the inverting terminal of the first operational amplifier; a drain of the third MOS transistor, a source of the seventh MOS transistor and a drain of the ninth MOS transistor are connected; a gate and a drain of the fourth MOS transistor, a gate of the fifth MOS transistor and a drain of the sixth MOS transistor are connected; a drain of the fifth MOS transistor, a drain of the seventh MOS transistor, a gate of the tenth MOS transistor, a gate of the fifteenth MOS transistor and one terminal of the sixth capacitor are connected; a gate of the sixth MOS transistor, a gate of the seventh MOS transistor, a gate of the twenty-second MOS transistor, a gate and a drain of the twenty-third MOS transistor, a source of the twenty-fifth MOS transistor and a gate of the seventh MOS transistor are connected; a substrate of the sixth MOS transistor, a source and a substrate of the eighth MOS transistor, a source and a substrate of the ninth MOS transistor, a substrate of the seventh MOS transistor, a source and a substrate of the eleventh MOS transistor, a source and a substrate of the fourteenth MOS transistor, a source and a substrate of the sixteenth MOS transistor, a source and a substrate of the twentieth MOS transistor, a source and a substrate of the twenty-first MOS transistor, a substrate of the twenty-sixth MOS transistor, a source and a substrate of the twenty-seventh MOS transistor and one terminal of the sixth resistor are all grounded; a gate of the eighth MOS transistor, a gate of the ninth MOS transistor, a gate of the twenty-fourth MOS transistor, a gate and a drain of the twenty-fifth MOS transistor, a drain of the twenty-sixth MOS transistor and a gate of the nineteenth MOS transistor are connected; a drain of the tenth MOS transistor, a gate and a drain of the eleventh MOS transistor and a gate of the fourteenth MOS transistor are connected; a drain of the twelfth MOS transistor, a source of the thirteenth MOS transistor and one terminal of the seventh capacitor are connected; a gate of the thirteenth MOS transistor, a drain of the nineteenth MOS transistor, a drain and a gate of the twentieth MOS transistor and a gate of the twenty-first MOS transistor are connected; a drain of the thirteenth MOS transistor, a drain of the fourteenth MOS transistor and a gate of the sixteenth MOS transistor are connected; a drain of the fifteenth MOS transistor, the other terminal of the sixth capacitor, the other terminal of the seventh capacitor and a drain of the sixteenth MOS transistor are connected, and a connecting terminal serves as the output terminal of the first operational amplifier; a drain of the seventeenth MOS transistor and a source of the nineteenth MOS transistor are connected; a drain of the twenty-second MOS transistor and a source of the twenty-fourth MOS transistor are connected; a drain of the twenty-fourth MOS transistor, a drain of the twenty-seventh MOS transistor and a gate of the twenty-sixth MOS transistor are connected; and a source of the twenty-sixth MOS transistor, a gate of the twenty-seventh MOS transistor and the other terminal of the sixth resistor are connected.

The proportional amplifier includes a second operational amplifier, a first resistor and a second resistor, wherein the second operational amplifier has a non-inverting input terminal, an inverting input terminal and an output terminal; one terminal of the first resistor serves as the input terminal of the proportional amplifier; the other terminal of the first resistor, one terminal of the second resistor and the inverting input terminal of the second operational amplifier are connected; the non-inverting terminal of the second operational amplifier is grounded; and the other terminal of the second resistor and the output terminal of the second operational amplifier are connected, and a connecting terminal serves as the output terminal of the proportional amplifier.

The filter includes a third resistor and a third capacitor, wherein one terminal of the third resistor serves as the input terminal of the filter; the other terminal of the third resistor is connected to one terminal of the third capacitor, and the other terminal of the third capacitor serves as the output terminal of the filter.

The sample-hold circuit includes a third operational amplifier, a fourth capacitor, a fourth electronic switch and a fifth electronic switch, wherein the third operational amplifier has a non-inverting input terminal, an inverting input terminal and an output terminal; the fourth electronic switch and the fifth electronic switch each have a clock terminal and two connecting terminals, a clock signal for controlling the two connecting terminals to be connected or disconnected is input to the clock terminal, and the two connecting terminals are respectively referred to as a first connecting terminal and a second connecting terminal; the first connecting terminal of the fourth electronic switch and the first connecting terminal of the fifth electronic switch are connected, and a connecting terminal serves as the input terminal of the sample-hold circuit; the second connecting terminal of the fifth electronic switch is grounded; the second connecting terminal of the fourth electronic switch, one terminal of the fourth capacitor and the inverting input terminal of the third operational amplifier are connected; and the non-inverting terminal and the output terminal of the third operational amplifier are connected, and a connecting terminal serves as the output terminal of the sample-hold circuit.

The integrator includes a fourth operational amplifier, a fourth resistor, a fifth resistor and a fifth capacitor, wherein the fourth operational amplifier has a non-inverting input terminal, an inverting input terminal and an output terminal; one terminal of the fourth resistor and one terminal of the fifth capacitor are connected, and a connecting terminal serves as the input terminal of the integrator; the other terminal of the fourth resistor and the inverting terminal of the fourth operational amplifier are connected; the non-inverting terminal of the fourth operational amplifier is grounded; the other terminal of the fifth capacitor and one terminal of the fifth resistor are connected; and the other terminal of the fifth resistor and the output terminal of the fourth operational amplifier are connected, and a connecting terminal serves as the output terminal of the integrator.

The buffer includes a fifth operational amplifier and a sixth electronic switch, wherein the fifth operational amplifier has a non-inverting input terminal, an inverting input terminal and an output terminal; the sixth electronic switch has a clock terminal and two connecting terminals, a clock signal for controlling the two connecting terminals to be connected or disconnected is input to the clock terminal, and the two connecting terminals are respectively referred to as a first connecting terminal and a second connecting terminal; the inverting input terminal of the fifth operational amplifier serves as the input terminal of the buffer; the non-inverting input terminal of the fifth operational amplifier, the output terminal of the fifth operational amplifier and the first connecting terminal of the sixth electronic switch are connected; and the second connecting terminal of the sixth electronic switch serves as the output terminal of the buffer.

Compared with the prior art, the invention has the following advantages: the silicon gyroscope detection circuit is formed by the charge amplifier, the proportional amplifier, the filter, the sample-hold circuit, the integrator and the buffer; the charge amplifier, the proportional amplifier and the filter constitute a detection branch to sequentially convert, amplify and filter a charge signal generated by inductive rotation of a silicon gyroscope, thus improving the signal-to-noise ratio and the detection precision; and the sample-hold circuit, the integrator and the buffer constitute a feedback branch to sample, amplify and buffer a detection signal in real time to form a feedback signal, which is fed back to the charge amplifier and superimposed with the charge signal generated by inductive rotation of the silicon gyroscope, such that a closed-loop detection process is formed to compensate for in real time errors caused by interferences including noise, temperature, nonlinearity and circuit parameter variations, thus improving the detection precision and stability.

### BRIEF DESCRIPTION OF THE DRAWINGS

FIG. 1 is a structural diagram of a silicon gyroscope detection circuit according to the invention.

FIG. 2 is a circuit diagram of a first operational amplifier of the silicon gyroscope detection circuit according to the invention.

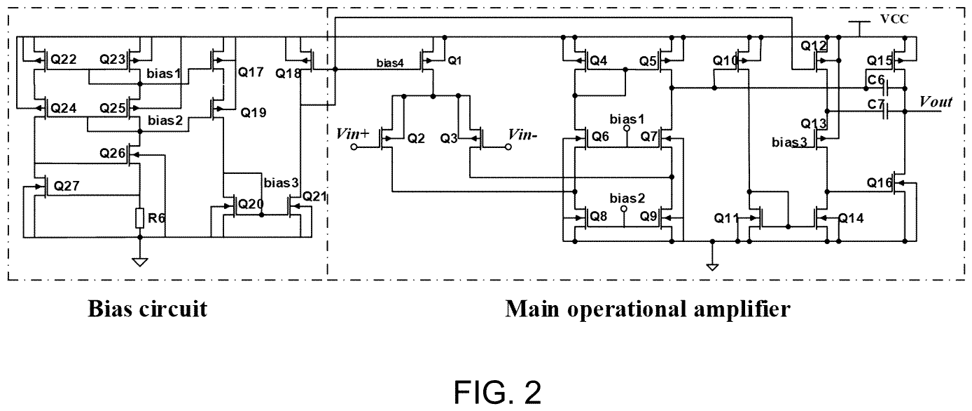

### DESCRIPTION OF THE EMBODIMENTS

The invention is described in further detail below in conjunction with accompanying drawings and embodiments.

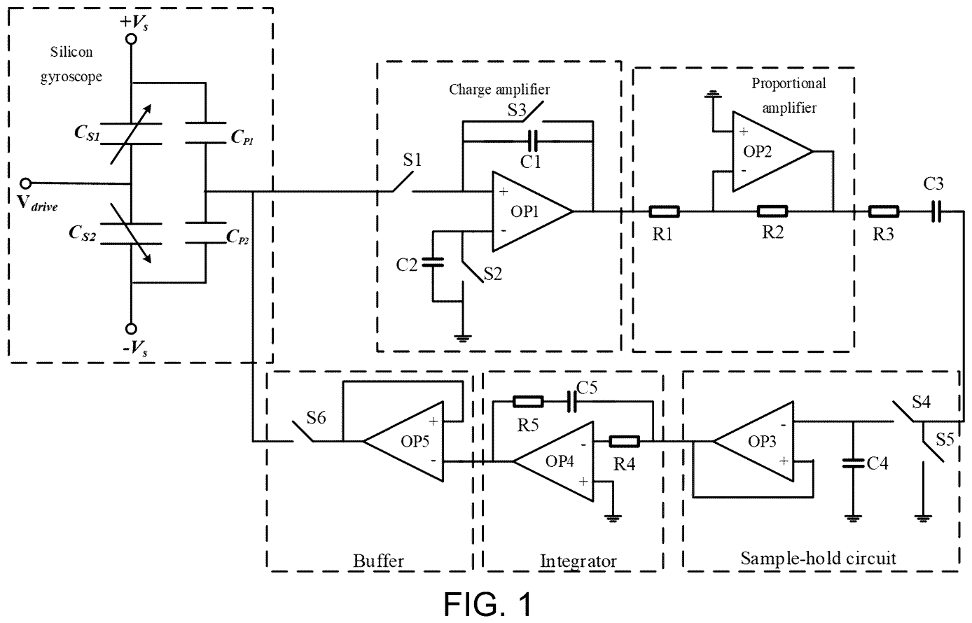

Embodiment 1: As shown in FIG. 1, a silicon gyroscope detection circuit based on sample-hold and integral feedback includes a charge amplifier, a proportional amplifier, a filter, a sample-hold circuit, an integrator and a buffer, wherein the charge amplifier is configured to convert a charge signal, generated by inductive rotation of a silicon gyroscope, into a voltage signal and output the voltage signal to the proportional amplifier, the proportional amplifier is configured to amplify the voltage signal, output thereto by the charge amplifier, to obtain an amplified signal and output the amplified signal to the filter, the filter is configured to filter the amplified signal to remove signals beyond an induction frequency band of the silicon gyroscope to obtain a signal within the induction frequency band of the silicon gyroscope and output the signal as a detection signal, the sample-hold circuit is configured to sample and hold the detection signal output by the filter to obtain a sampled signal and output the sampled signal to the integrator, the integrator is configured to perform integration on the sampled signal, output thereto by the sample-hold circuit, to obtain an integrated signal and output the integrated signal to the buffer, and the buffer is configured to buffer the integrated signal, output thereto by the integrator, to obtain a buffer signal and feed the buffer signal to the charge amplifier as a feedback signal, which is superimposed with the charge signal generated by inductive rotation of the silicon gyroscope to compensate for an error, caused by interferences including noise, temperature, nonlinearity and circuit parameter variations, to calibrate the detection signal output by the filter.

In this embodiment, the charge amplifier, the proportional amplifier and the filter constitute a detection branch to sequentially convert, amplify and filter the charge signal generated by inductive rotation of the silicon gyroscope, thus improving the signal-to-noise ratio and the detection accuracy; the sample-hold circuit, the integrator and the buffer constitute a feedback circuit to form a feedback mechanism to sample, amplify and buffer the sampled signal to form the feedback signal, which is fed back to the charge amplifier to be superimposed with the charge signal generated by inductive rotation of the silicon gyroscope, such that a closed-loop detection process is formed to compensate for in real time, by real-time feedback and adjustment, errors caused by interferences including noise, temperature, nonlinearity and circuit parameter variations, thus effectively restraining external interferences and noise; moreover, by continuous feedback and adjustment, the zero drift of the silicon gyroscope detection circuit is significantly reduced, and high precision can still be maintained after long-term use, thus improving the accuracy and stability of the detection signal.

Embodiment 2: This embodiment is basically identical with Embodiment 1 and is different from Embodiment 1 in the following aspect: in this embodiment, the charge amplifier, the proportional amplifier, the filter, the sample-hold circuit, the integrator and the buffer each have an input terminal and an output terminal, wherein the input terminal of the charge amplifier serves as an input terminal of the silicon gyroscope detection circuit, is connected to an output terminal of the silicon gyroscope and allows the charge signal generated by inductive rotation of the silicon gyroscope to be input thereto, the output terminal of the charge amplifier is connected to the input terminal of the proportional amplifier, the output terminal of the proportional amplifier is connected to the input terminal of the filter, the output terminal of the filter serves as an output terminal of the silicon gyroscope detection circuit and is configured to output the detection signal, the input terminal of the sample-hold circuit is connected to the output terminal of the filter, the output terminal of the sample-hold circuit is connected to the input terminal of the integrator, the output terminal of the integrator is connected to the input terminal of the buffer, and the output terminal of the buffer is connected to the input terminal of the charge amplifier and configured to output the buffer signal to the input terminal of the charge amplifier.

In this embodiment, the charge amplifier includes a first operational amplifier OP1, a first electronic switch S1, a second electronic switch S2, a third electronic switch S3, a first capacitor C1 and a second capacitor C2, wherein the first operational amplifier OP1 has a non-inverting input terminal, an inverting input terminal and an output terminal; the first electronic switch S1, the second electronic switch S2 and the third electronic switch S3 each have a clock terminal and two connecting terminals, a clock signal for controlling the two connecting terminals to be connected or disconnected is input to the clock terminal, and the two connecting terminals are respectively referred to as a first connecting terminal and a second connecting terminal; the first connecting terminal of the first electronic switch S1 serves as the input terminal of the charge amplifier; the second connecting terminal of the first electronic switch S1, the non-inverting input terminal of the first operational amplifier OP1, the first connecting terminal of the third electronic switch S3 and one terminal of the first capacitor C1 are connected; the inverting input terminal of the first operational amplifier OP1, one terminal of the second capacitor C2 and the first connecting terminal of the second electronic switch S2 are connected; the other terminal of the second capacitor C2 and the second connecting terminal of the second electronic switch S2 are both grounded; and the second connecting terminal of the third electronic switch S3, the other terminal of the first capacitor C1 and the output terminal of the first operational amplifier OP1 are connected, and a connecting terminal serves as the output terminal of the charge amplifier. Wherein, under the control of the clock signal, the first electronic switch S1, the second electronic switch S2 and the third electronic switch S3 control transmission and amplification of the signal in the charge amplifier; the first capacitor C1 is configured to feed the signal output by the output terminal of the first operational amplifier OP1 back to the non-inverting terminal of the first operational amplifier OP1 to form a feedback mechanism to compensate for the signal input to the non-inverting terminal of the first operational amplifier OP1, thus improving the signal-to-noise ratio; and the second capacitor C2 is configured to stabilize the first operational amplifier OP1 to ensure that the output terminal of the operational amplifier OP1 outputs a stable signal.

In this embodiment, the proportional amplifier includes a second operational amplifier OP2, a first resistor R1 and a second resistor R2, wherein the second operational amplifier OP2 has a non-inverting input terminal, an inverting input terminal and an output terminal; one terminal of the first resistor R1 serves as the input terminal of the proportional amplifier; the other terminal of the first resistor R1, one terminal of the second resistor R2 and the inverting input terminal of the second operational amplifier OP2 are connected; the non-inverting terminal of the second operational amplifier OP2 is grounded; and the other terminal of the second resistor R2 and the output terminal of the second operational amplifier OP2 are connected, and a connecting terminal serves as the output terminal of the proportional amplifier. Wherein, the second operational amplifier OP2 further amplifies a voltage output by the charge amplifier to increase the signal intensity, and the first resistor R1 and the second resistor R2 are configured to set the gain of the proportional amplifier.

In this embodiment, the filter includes a third resistor R3 and a third capacitor C3, wherein one terminal of the third resistor R3 serves as the input terminal of the filter; the other terminal of the third resistor R3 is connected to one terminal of the third capacitor C3, and the other terminal of the third capacitor C3 serves as the output terminal of the filter.

In this embodiment, the sample-hold circuit includes a third operational amplifier OP3, a fourth capacitor C4, a fourth electronic switch S4 and a fifth electronic switch S5, wherein the third operational amplifier OP3 has a non-inverting input terminal, an inverting input terminal and an output terminal; the fourth electronic switch S4 and the fifth electronic switch S5 each have a clock terminal and two connecting terminals, a clock signal for controlling the two connecting terminals to be connected or disconnected is input to the clock terminal, and the two connecting terminals are respectively referred to as a first connecting terminal and a second connecting terminal; the first connecting terminal of the fourth electronic switch S4 and the first connecting terminal of the fifth electronic switch S5 are connected, and a connecting terminal serves as the input terminal of the sample-hold circuit; the second connecting terminal of the fifth electronic switch S5 is grounded; the second connecting terminal of the fourth electronic switch S4, one terminal of the fourth capacitor C4 and the inverting input terminal of the third operational amplifier OP3 are connected; and the non-inverting terminal and the output terminal of the third operational amplifier OP3 are connected, and a connecting terminal serves as the output terminal of the sample-hold circuit. Wherein, the third operational amplifier OP3 is configured to sample and hold the detection signal output by the output terminal of the filter at a preset time, and the fourth capacitor C4 is configured to hold the sampled signal, and the fourth electronic switch S4 and the fifth electronic switch S5 are turned on or off under the control of the clock signal to control a sample-hold operation of the third operational amplifier OP3.

In this embodiment, the integrator includes a fourth operational amplifier OP4, a fourth resistor R4, a fifth resistor R5 and a fifth capacitor C5, wherein the fourth operational amplifier OP4 has a non-inverting input terminal, an inverting input terminal and an output terminal; one terminal of the fourth resistor R4 and one terminal of the fifth capacitor C5 are connected, and a connecting terminal serves as the input terminal of the integrator; the other terminal of the fourth resistor R4 and the inverting terminal of the fourth operational amplifier OP4 are connected; the non-inverting terminal of the fourth operational amplifier OP4 is grounded; the other terminal of the fifth capacitor C5 and one terminal of the fifth resistor R5 are connected; and the other terminal of the fifth resistor R5 and the output terminal of the fourth operational amplifier OP4 are connected, and a connecting terminal serves as the output terminal of the integrator. Wherein, the fourth operational amplifier OP4 is configured to perform integration on the input signal to generate a cumulative signal, and the fifth resistor R5, the fourth resistor R4 and the fifth capacitor C5 are configured to set a time constant of the integrator.

In this embodiment, the buffer includes a fifth operational amplifier OP5 and a sixth electronic switch S6, wherein the fifth operational amplifier OP5 has a non-inverting input terminal, an inverting input terminal and an output terminal; the sixth electronic switch S6 has a clock terminal and two connecting terminals, a clock signal for controlling the two connecting terminals to be connected or disconnected is input to the clock terminal, and the two connecting terminals are respectively referred to as a first connecting terminal and a second connecting terminal; the inverting input terminal of the fifth operational amplifier OP5 serves as the input terminal of the buffer; the non-inverting input terminal of the fifth operational amplifier OP5, the output terminal of the fifth operational amplifier OP5 and the first connecting terminal of the sixth electronic switch S6 are connected; and the second connecting terminal of the sixth electronic switch S6 serves as the output terminal of the buffer. Wherein, the fifth operational amplifier OP5 is configured to isolate and drive the signal to ensure that the signal will not be distorted when transmitted in the buffer, and the sixth electronic switch S6 is turned on or off under the control of the clock signal to control the transmission of the signal in the buffer.

As shown in FIG. 1, Cs1 and Cs2 indicate equivalent capacitances of the silicon gyroscope, Cp1 and Cp2 indicate parasitic capacitances of the silicon gyroscope, and Vdrive indicates a drive voltage used for exciting the silicon gyroscope to vibrate. When the silicon gyroscope rotates, Cs1, Cs2, Cp1 and Cp2 change, at this moment, the silicon gyroscope generates and outputs a weak charge signal, the charge signal is transmitted to the first operational amplifier OP1 by means of the first electronic switch S1 and the second electronic switch S2, the first operational amplifier OP1 converts the charge signal into a voltage signal and amplifies the voltage signal, the voltage signal is transmitted to the proportional amplifier, the second operational amplifier OP2 further amplify the intensity of the voltage signal to obtain an amplified signal, which is filtered by the third capacitor C3 of the filter to obtain and output a detection signal, the fourth electronic switch S4 and the fifth electronic switch S5 are turned on or off under the control of the clock signal to control a sample-hold operation of the third operational amplifier OP3 of the sample-hold circuit and hold a sampled signal in the fourth capacitor C4, the fourth operational amplifier OP4 performs integration on the sampled signal output by the sample-hold circuit to generate and output a cumulative signal (integrated signal), and the buffer, on one hand, isolates the charge signal to prevent the charge signal from being transmitted along a feedback branch, and on the other hand, buffers the integrated signal and then outputs the buffer signal to the input terminal of the charge amplifier as a feedback signal for compensation to calibrate the detection signal.

Embodiment 3: This embodiment is basically identical with Embodiment 2 and is different from Embodiment 2 in the following aspect: In this embodiment, the first operational amplifier includes a first MOS transistor Q1, a second MOS transistor Q2, a third MOS transistor Q3, a fourth MOS transistor Q4, a fifth MOS transistor Q5, a sixth MOS transistor Q6, a seventh MOS transistor Q7, an eighth MOS transistor Q8, a ninth MOS transistor Q9, a tenth MOS transistor Q10, an eleventh MOS transistor Q11, a twelfth MOS transistor Q12, a thirteenth MOS transistor Q13, a fourteenth MOS transistor Q14, a fifteenth MOS transistor Q15, a sixteenth MOS transistor Q16, a seventeenth MOS transistor Q17, an eighteenth MOS transistor Q18, a nineteenth MOS transistor Q19, a twentieth MOS transistor Q20, a twenty-first MOS transistor Q21, a twenty-second MOS transistor Q22, a twenty-third MOS transistor Q23, a twenty-fourth MOS transistor Q24, a twenty-fifth MOS transistor Q25, a twenty-sixth MOS transistor Q26, a twenty-seventh MOS transistor Q27, a sixth resistor R6, a sixth capacitor C6 and a seventh capacitor C7, wherein the first MOS transistor Q1, the second MOS transistor Q2, the third MOS transistor Q3, the fourth MOS transistor Q4, the fifth MOS transistor Q5, the tenth MOS transistor Q10, the twelfth MOS transistor Q12, the thirteenth MOS transistor Q13, the fifteenth MOS transistor Q15, the seventeenth MOS transistor Q17, the eighteenth MOS transistor Q18, the nineteenth MOS transistor Q18, the twenty-second MOS transistor Q22, the twenty-third MOS transistor Q23, the twenty-fourth MOS transistor Q24 and the twenty-fifth MOS transistor Q25 are all PMOS transistors; the sixth MOS transistor Q6, the seventh MOS transistor Q7, the eighth MOS transistor Q8, the ninth MOS transistor Q9, the eleventh MOS transistor Q11, the fourteenth MOS transistor, the sixteenth MOS transistor, the twentieth MOS transistor, the twenty-first MOS transistor Q14, the twenty-sixth MOS transistor Q26 and the twenty-seventh MOS transistor Q27 are all NMOS transistors; a supply voltage VCC is accessed to a source and a substrate of the first MOS transistor Q1, a source and a substrate of the fourth MOS transistor Q4, a source and a substrate of the fifth MOS transistor Q5, a source and a substrate of the tenth MOS transistor Q10, a source and a substrate of the twelfth MOS transistor Q12, a substrate of the thirteenth MOS transistor Q13, a source and a substrate of the fifteenth MOS transistor Q15, a source and a substrate of the seventeenth MOS transistor Q17, a source and a substrate of the eighteenth MOS transistor Q18, a substrate of the nineteenth MOS transistor Q19, a source and a substrate of the twenty-second MOS transistor Q22, a source and a substrate of the twenty-third MOS transistor Q23, a substrate of the twenty-fourth MOS transistor Q24 and a substrate of the twenty-fifth MOS transistor Q25; a gate of the first MOS transistor Q1, a gate and a drain of the eighteenth MOS transistor Q18, a drain of the twenty-first MMOS transistor Q21 and a gate of the twelfth MOS transistor Q12 are connected; a drain of the first MOS transistor Q1 is connected to a source and a substrate of the second MOS transistor Q2 and a source and a substrate of the third MOS transistor Q3; a gate of the second MOS transistor Q2 serves as the non-inverting input terminal of the first operational amplifier OP1; a drain of the second MOS transistor Q2, a source of the sixth MOS transistor Q6 and a drain of the eighth MOS transistor Q8 are connected; a gate of the third MOS transistor Q3 serves as the inverting terminal of the first operational amplifier OP1; a drain of the third MOS transistor Q3, a source of the seventh MOS transistor Q7 and a drain of the ninth MOS transistor Q9 are connected; a gate and a drain of the fourth MOS transistor Q4, a gate of the fifth MOS transistor Q5 and a drain of the sixth MOS transistor Q6 are connected; a drain of the fifth MOS transistor Q5, a drain of the seventh MOS transistor Q7, a gate of the tenth MOS transistor Q10, a gate of the fifteenth MOS transistor Q15 and one terminal of the sixth capacitor C6 are connected; a gate of the sixth MOS transistor Q6, a gate of the seventh MOS transistor Q7, a gate of the twenty-second MOS transistor Q22, a gate and a drain of the twenty-third MOS transistor Q23, a source of the twenty-fifth MOS transistor Q25 and a gate of the seventh MOS transistor Q7 are connected; a substrate of the sixth MOS transistor Q6, a source and a substrate of the eighth MOS transistor Q8, a source and a substrate of the ninth MOS transistor Q9, a substrate of the seventh MOS transistor Q7, a source and a substrate of the eleventh MOS transistor Q11, a source and a substrate of the fourteenth MOS transistor Q14, a source and a substrate of the sixteenth MOS transistor Q16, a source and a substrate of the twentieth MOS transistor Q20, a source and a substrate of the twenty-first MOS transistor Q21, a substrate of the twenty-sixth MOS transistor Q26, a source and a substrate of the twenty-seventh MOS transistor Q27 and one terminal of the sixth resistor R6 are all grounded; a gate of the eighth MOS transistor Q8, a gate of the ninth MOS transistor Q9, a gate of the twenty-fourth MOS transistor Q24, a gate and a drain of the twenty-fifth MOS transistor Q25, a drain of the twenty-sixth MOS transistor Q26 and a gate of the nineteenth MOS transistor Q19 are connected; a drain of the tenth MOS transistor Q10, a gate and a drain of the eleventh MOS transistor Q11 and a gate of the fourteenth MOS transistor Q14 are connected; a drain of the twelfth MOS transistor Q12, a source of the thirteenth MOS transistor Q13 and one terminal of the seventh capacitor C7 are connected; a gate of the thirteenth MOS transistor Q13, a drain of the nineteenth MOS transistor Q19, a drain and a gate of the twentieth MOS transistor Q20 and a gate of the twenty-first MOS transistor Q21 are connected; a drain of the thirteenth MOS transistor Q13, a drain of the fourteenth MOS transistor Q14 and a gate of the sixteenth MOS transistor Q16 are connected; a drain of the fifteenth MOS transistor Q15, the other terminal of the sixth capacitor C6, the other terminal of the seventh capacitor C7 and a drain of the sixteenth MOS transistor Q16 are connected, and a connecting terminal serves as the output terminal of the first operational amplifier OP1; a drain of the seventeenth MOS transistor Q17 and a source of the nineteenth MOS transistor Q19 are connected; a drain of the twenty-second MOS transistor Q22 and a source of the twenty-fourth MOS transistor Q24 are connected; a drain of the twenty-fourth MOS transistor Q24, a drain of the twenty-seventh MOS transistor Q27 and a gate of the twenty-sixth MOS transistor Q26 are connected; and a source of the twenty-sixth MOS transistor Q26, a gate of the twenty-seventh MOS transistor Q27 and the other terminal of the sixth resistor R6 are connected.

In this embodiment, the second operational amplifier OP2, the third operational amplifier OP3, the fourth operational amplifier OP4 and the fifth operational amplifier OP5 may adopt the same circuit structure as the first operational amplifier OP1 and may also be implemented by other mature techniques in the art.

In this embodiment, in the first operational amplifier OP1, the first MOS transistor Q1, the second MOS transistor Q2, the third MOS transistor Q3, the fourth MOS transistor Q4, the fifth MOS transistor Q5, the sixth MOS transistor Q6, the seventh MOS transistor Q7, the eighth MOS transistor Q8, the ninth MOS transistor Q9, the tenth MOS transistor Q10, the eleventh MOS transistor Q11, the twelfth MOS transistor Q12, the thirteenth MOS transistor Q13, the fourteenth MOS transistor Q14, the fifteenth MOS transistor Q15, the sixteenth MOS transistor Q16, the sixth capacitor C6 and the seventh capacitor C7 constitute a main operational amplifier; the first MOS transistor Q1, the second MOS transistor Q2 and the third MOS transistor Q3 constitute a differential amplifying portion used for amplifying a difference between differential input signals input to the positive input terminal and the negative input terminal of the first operational amplifier OP1; the fourth MOS transistor Q4, the fifth MOS transistor Q5, the sixth MOS transistor Q6, the seventh MOS transistor Q7, the eighth MOS transistor Q8, the ninth MOS transistor Q9, the tenth MOS transistor Q10, the eleventh MOS transistor Q11, the twelfth MOS transistor Q12, the thirteenth MOS transistor Q13, the fourteenth MOS transistor Q14, the fifteenth MOS transistor Q15 and the sixteenth MOS transistor Q16 constitute a multi-stage amplifying portion to further increase the gain of the signal; the fifteenth MOS transistor and the sixteenth MOS transistor together with the sixth capacitor C6 and the seventh capacitor C7 constitute an output stage to provide and output a finally amplified signal by driving a load; the seventeenth MOS transistor Q17, the eighteenth MOS transistor Q18, the nineteenth MOS transistor Q19, the twentieth MOS transistor Q20, the twenty-first MOS transistor Q21, the twenty-second MOS transistor Q22, the twenty-third MOS transistor Q23, the twenty-fourth MOS transistor Q24, the twenty-fifth MOS transistor Q25, the twenty-sixth MOS transistor Q26, the twenty-seventh MOS transistor Q27 and the sixth resistor R6 form a bias circuit to provide a stable bias current or voltage for the main operational amplifier to ensure that the main operational amplifier operates normally; the twenty-second MOS transistor Q22, the twenty-third MOS transistor Q23, the twenty-fourth MOS transistor Q24, the twenty-fifth MOS transistor Q25, the twenty-sixth MOS transistor Q26 and the twenty-seventh MOS transistor Q27 constitute a plurality of current mirror circuits to generate stable bias currents, which are transmitted to different portions of the main operational amplifier by means of a node bias1, a node bias2 and a node bias3; and by providing these stable bias currents by means of the bias circuit, the operating point of the main operational amplifier is stabilized within an appropriate range, thus avoiding drifts of the operating point caused by temperature variations or process fluctuations.

In this embodiment, by means of the bias circuit of the first operational amplifier OP1, the operating point of the main operational amplifier is well controlled, thus improving the stability of the operating point of the main operational amplifier; the bias circuit effectively reduces the influence of temperature on the performance of the charge amplifier to keep the current stable, thus improving the consistency of the performance of the charge amplifier in different environments; in addition, the multi-stage amplification structure increases the gain and is suitable for precision signal amplification; and the stable operating point and specific circuit structure of the main operational amplifier reduce nonlinear distortion in the amplification process, thus improving the fidelity of output signals.

To sum up, the silicon gyroscope detection circuit provided by the invention adopts a closed-loop detection process to compensate for in real time errors caused by interferences including noise, temperature, nonlinearity and circuit parameters variations, thus improving the detection precision and stability.

What is claimed is:

1. A silicon gyroscope detection circuit based on sample-hold and integral feedback, wherein includes a charge amplifier, a proportional amplifier, a filter, a sample-hold circuit, an integrator and a buffer, wherein the charge amplifier is configured to convert a charge signal, generated by inductive rotation of a silicon gyroscope, into a voltage signal and output the voltage signal to the proportional amplifier, the proportional amplifier is configured to amplify the voltage signal, output thereto by the charge amplifier, to obtain an amplified signal and output the amplified signal to the filter, the filter is configured to filter the amplified signal to remove signals beyond an induction frequency band of the silicon gyroscope to obtain a signal within the induction frequency band of the silicon gyroscope and output the signal as a detection signal, the sample-hold circuit is configured to sample and hold the detection signal output by the filter to obtain a sampled signal and output the sampled signal to the integrator, the integrator is configured to perform integration on the sampled signal, output thereto by the sample-hold circuit, to obtain an integrated signal and output the integrated signal to the buffer, and the buffer is configured to buffer the integrated signal, output thereto by the integrator, to obtain a buffer signal and feed the buffer signal to the charge amplifier as a feedback signal, which is superimposed with the charge signal generated by inductive rotation of the silicon gyroscope to compensate for an error, caused by interferences including noise, temperature, nonlinearity and circuit parameter variations, to calibrate the detection signal output by the filter.

2. The silicon gyroscope detection circuit based on sample-hold and integral feedback, according to claim 1, wherein the charge amplifier, the proportional amplifier, the filter, the sample-hold circuit, the integrator and the buffer each have an input terminal and an output terminal, wherein the input terminal of the charge amplifier serves as an input terminal of the silicon gyroscope detection circuit, is connected to an output terminal of the silicon gyroscope and allows the charge signal generated by inductive rotation of the silicon gyroscope to be input thereto, the output terminal of the charge amplifier is connected to the input terminal of the proportional amplifier, the output terminal of the proportional amplifier is connected to the input terminal of the filter, the output terminal of the filter serves as an output terminal of the silicon gyroscope detection circuit and is configured to output the detection signal, the input terminal of the sample-hold circuit is connected to the output terminal of the filter, the output terminal of the sample-hold circuit is connected to the input terminal of the integrator, the output terminal of the integrator is connected to the input terminal of the buffer, and the output terminal of the buffer is connected to the input terminal of the charge amplifier and configured to output the buffer signal to the input terminal of the charge amplifier.

3. The silicon gyroscope detection circuit based on sample-hold and integral feedback, according to claim 2, wherein the charge amplifier includes a first operational amplifier, a first electronic switch, a second electronic switch, a third electronic switch, a first capacitor and a second capacitor, wherein the first operational amplifier has a non-inverting input terminal, an inverting input terminal and an output terminal; the first electronic switch, the second electronic switch and the third electronic switch each have a clock terminal and two connecting terminals, a clock signal for controlling the two connecting terminals to be connected or disconnected is input to the clock terminal, and the two connecting terminals are respectively referred to as a first connecting terminal and a second connecting terminal; the first connecting terminal of the first electronic switch serves as the input terminal of the charge amplifier; the second connecting terminal of the first electronic switch, the non-inverting input terminal of the first operational amplifier, the first connecting terminal of the third electronic switch and one terminal of the first capacitor are connected; the inverting input terminal of the first operational amplifier, one terminal of the second capacitor and the first connecting terminal of the second electronic switch are connected; the other terminal of the second capacitor and the second connecting terminal of the second electronic switch are both grounded; and the second connecting terminal of the third electronic switch, the other terminal of the first capacitor and the output terminal of the first operational amplifier are connected, and a connecting terminal serves as the output terminal of the charge amplifier.

4. The silicon gyroscope detection circuit based on sample-hold and integral feedback, according to claim 3, wherein the first operational amplifier includes a first MOS transistor, a second MOS transistor, a third MOS transistor, a fourth MOS transistor, a fifth MOS transistor, a sixth MOS transistor, a seventh MOS transistor, an eighth MOS transistor, a ninth MOS transistor, a tenth MOS transistor, an eleventh MOS transistor, a twelfth MOS transistor, a thirteenth MOS transistor, a fourteenth MOS transistor, a fifteenth MOS transistor, a sixteenth MOS transistor, a seventeenth MOS transistor, an eighteenth MOS transistor, a nineteenth MOS transistor, a twentieth MOS transistor, a twenty-first MOS transistor, a twenty-second MOS transistor, a twenty-third MOS transistor, a twenty-fourth MOS transistor, a twenty-fifth MOS transistor, a twenty-sixth MOS transistor, a twenty-seventh MOS transistor, a sixth resistor, a sixth capacitor and a seventh capacitor, wherein the first MOS transistor, the second MOS transistor, the third MOS transistor, the fourth MOS transistor, the fifth MOS transistor, the tenth MOS transistor, the twelfth MOS transistor, the thirteenth MOS transistor, the fifteenth MOS transistor, the seventeenth MOS transistor, the eighteenth MOS transistor, the nineteenth MOS transistor, the twenty-second MOS transistor, the twenty-third MOS transistor, the twenty-fourth MOS transistor and the twenty-fifth MOS transistor are all PMOS transistors; the sixth MOS transistor, the seventh MOS transistor, the eighth MOS transistor, the ninth MOS transistor, the eleventh MOS transistor, the fourteenth MOS transistor, the sixteenth MOS transistor, the twentieth MOS transistor, the twenty-first MOS transistor, the twenty-sixth MOS transistor and the twenty-seventh MOS transistor are all NMOS transistors; a supply voltage is accessed to a source and a substrate of the first MOS transistor, a source and a substrate of the fourth MOS transistor, a source and a substrate of the fifth MOS transistor, a source and a substrate of the tenth MOS transistor, a source and a substrate of the twelfth MOS transistor, a substrate of the thirteenth MOS transistor, a source and a substrate of the fifteenth MOS transistor, a source and a substrate of the seventeenth MOS transistor, a source and a substrate of the eighteenth MOS transistor, a substrate of the nineteenth MOS transistor, a source and a substrate of the twenty-second MOS transistor, a source and a substrate of the twenty-third MOS transistor, a substrate of the twenty-fourth MOS transistor and a substrate of the twenty-fifth MOS transistor; a gate of the first MOS transistor, a gate and a drain of the eighteenth MOS transistor, a drain of the twenty-first MMOS transistor and a gate of the twelfth MOS transistor are connected; a drain of the first MOS transistor is connected to a source and a substrate of the second MOS transistor and a source and a substrate of the third MOS transistor; a gate of the second MOS transistor serves as the non-inverting input terminal of the first operational amplifier; a drain of the second MOS transistor, a source of the sixth MOS transistor and a drain of the eighth MOS transistor are connected; a gate of the third MOS transistor serves as the inverting terminal of the first operational amplifier; a drain of the third MOS transistor, a source of the seventh MOS transistor and a drain of the ninth MOS transistor are connected; a gate and a drain of the fourth MOS transistor, a gate of the fifth MOS transistor and a drain of the sixth MOS transistor are connected; a drain of the fifth MOS transistor, a drain of the seventh MOS transistor, a gate of the tenth MOS transistor, a gate of the fifteenth MOS transistor and one terminal of the sixth capacitor are connected; a gate of the sixth MOS transistor, a gate of the seventh MOS transistor, a gate of the twenty-second MOS transistor, a gate and a drain of the twenty-third MOS transistor, a source of the twenty-fifth MOS transistor and a gate of the seventh MOS transistor are connected; a substrate of the sixth MOS transistor, a source and a substrate of the eighth MOS transistor, a source and a substrate of the ninth MOS transistor, a substrate of the seventh MOS transistor, a source and a substrate of the eleventh MOS transistor, a source and a substrate of the fourteenth MOS transistor, a source and a substrate of the sixteenth MOS transistor, a source and a substrate of the twentieth MOS transistor, a source and a substrate of the twenty-first MOS transistor, a substrate of the twenty-sixth MOS transistor, a source and a substrate of the twenty-seventh MOS transistor and one terminal of the sixth resistor are all grounded; a gate of the eighth MOS transistor, a gate of the ninth MOS transistor, a gate of the twenty-fourth MOS transistor, a gate and a drain of the twenty-fifth MOS transistor, a drain of the twenty-sixth MOS transistor and a gate of the nineteenth MOS transistor are connected; a drain of the tenth MOS transistor, a gate and a drain of the eleventh MOS transistor and a gate of the fourteenth MOS transistor are connected; a drain of the twelfth MOS transistor, a source of the thirteenth MOS transistor and one terminal of the seventh capacitor are connected; a gate of the thirteenth MOS transistor, a drain of the nineteenth MOS transistor, a drain and a gate of the twentieth MOS transistor and a gate of the twenty-first MOS transistor are connected; a drain of the thirteenth MOS transistor, a drain of the fourteenth MOS transistor and a gate of the sixteenth MOS transistor are connected; a drain of the fifteenth MOS transistor, the other terminal of the sixth capacitor, the other terminal of the seventh capacitor and a drain of the sixteenth MOS transistor are connected, and a connecting terminal serves as the output terminal of the first operational amplifier; a drain of the seventeenth MOS transistor and a source of the nineteenth MOS transistor are connected; a drain of the twenty-second MOS transistor and a source of the twenty-fourth MOS transistor are connected; a drain of the twenty-fourth MOS transistor, a drain of the twenty-seventh MOS transistor and a gate of the twenty-sixth MOS transistor are connected; and a source of the twenty-sixth MOS transistor, a gate of the twenty-seventh MOS transistor and the other terminal of the sixth resistor are connected.

5. The silicon gyroscope detection circuit based on sample-hold and integral feedback, according to claim 2, wherein the proportional amplifier includes a second operational amplifier, a first resistor and a second resistor, wherein the second operational amplifier has a non-inverting input terminal, an inverting input terminal and an output terminal; one terminal of the first resistor serves as the input terminal of the proportional amplifier; the other terminal of the first resistor, one terminal of the second resistor and the inverting input terminal of the second operational amplifier are connected; the non-inverting terminal of the second operational amplifier is grounded; and the other terminal of the second resistor and the output terminal of the second operational amplifier are connected, and a connecting terminal serves as the output terminal of the proportional amplifier.

6. The silicon gyroscope detection circuit based on sample-hold and integral feedback, according to claim 2, wherein the filter includes a third resistor and a third capacitor, wherein one terminal of the third resistor serves as the input terminal of the filter; the other terminal of the third resistor is connected to one terminal of the third capacitor, and the other terminal of the third capacitor serves as the output terminal of the filter.

7. The silicon gyroscope detection circuit based on sample-hold and integral feedback, according to claim 2, wherein the sample-hold circuit includes a third operational amplifier, a fourth capacitor, a fourth electronic switch and a fifth electronic switch, wherein the third operational amplifier has a non-inverting input terminal, an inverting input terminal and an output terminal; the fourth electronic switch and the fifth electronic switch each have a clock terminal and two connecting terminals, a clock signal for controlling the two connecting terminals to be connected or disconnected is input to the clock terminal, and the two connecting terminals are respectively referred to as a first connecting terminal and a second connecting terminal; the first connecting terminal of the fourth electronic switch and the first connecting terminal of the fifth electronic switch are connected, and a connecting terminal serves as the input terminal of the sample-hold circuit; the second connecting terminal of the fifth electronic switch is grounded; the second connecting terminal of the fourth electronic switch, one terminal of the fourth capacitor and the inverting input terminal of the third operational amplifier are connected; and the non-inverting terminal and the output terminal of the third operational amplifier are connected, and a connecting terminal serves as the output terminal of the sample-hold circuit.

8. The silicon gyroscope detection circuit based on sample-hold and integral feedback, according to claim 2, wherein the integrator includes a fourth operational amplifier, a fourth resistor, a fifth resistor and a fifth capacitor, wherein the fourth operational amplifier has a non-inverting input terminal, an inverting input terminal and an output terminal; one terminal of the fourth resistor and one terminal of the fifth capacitor are connected, and a connecting terminal serves as the input terminal of the integrator; the other terminal of the fourth resistor and the inverting terminal of the fourth operational amplifier are connected; the non-inverting terminal of the fourth operational amplifier is grounded; the other terminal of the fifth capacitor and one terminal of the fifth resistor are connected; and the other terminal of the fifth resistor and the output terminal of the fourth operational amplifier are connected, and a connecting terminal serves as the output terminal of the integrator.

9. The silicon gyroscope detection circuit based on sample-hold and integral feedback, according to claim 2, wherein the buffer includes a fifth operational amplifier and a sixth electronic switch, wherein the fifth operational amplifier has a non-inverting input terminal, an inverting input terminal and an output terminal; the sixth electronic switch has a clock terminal and two connecting terminals, a clock signal for controlling the two connecting terminals to be connected or disconnected is input to the clock terminal, and the two connecting terminals are respectively referred to as a first connecting terminal and a second connecting terminal; the inverting input terminal of the fifth operational amplifier serves as the input terminal of the buffer; the non-inverting input terminal of the fifth operational amplifier, the output terminal of the fifth operational amplifier and the first connecting terminal of the sixth electronic switch are connected; and the second connecting terminal of the sixth electronic switch serves as the output terminal of the buffer.
